(19) United States
(12) Patent Application Publication
(10) Pub. No.: US 2013/0067281 A1
(43) Pub. Date: Mar. 14, 2013

(54) TESTING SYSTEM AND METHOD FOR HANDHELD ELECTRONIC DEVICE

(71) Applicants: FENG-JUNG LEE, TAIPEI CITY (TW); CHING-FENG HSIEH, TAIPEI CITY (TW)

(72) Inventors: FENG-JUNG LEE, TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/278,225

(22) Filed: Oct. 21, 2011

(30) Foreign Application Priority Data
Sep. 9, 2011 (TW) 100132751

(51) Int. Cl. G06F 11/28

(52) U.S. Cl. 714/35; 714/E11.178

(57) ABSTRACT

A handheld electronic device testing system and a method for testing a handheld electronic device installed with an open operating platform and installed with a test instruction execution program are introduced. The test instruction execution program executes a functional test based on a test instruction received. The testing method involves integrating various test programs with a pre-stored test program library, sending sequentially an instruction to the test instruction execution program with each of the test programs through a transmission line in a scheduled manner, and recording a test result to achieve automated testing.

### CROSS-REFERENCE TO RELATED APPLICATION

This non-provisional application claims priority under 35 U.S.C. § 119(a) on Patent Application No(s).100132751 filed in Taiwan, R.O.C. on Sep. 9, 2011, the entire contents of which are hereby incorporated by reference.

### FIELD OF TECHNOLOGY The present invention relates to testing systems and methods, and more particularly, to a testing system and method for a handheld electronic device.

### BACKGROUND

Due to the prevalence of handheld electronic devices, such as smartphones and tablet computers, a wide variety of handheld electronic devices are commercially available, and the handheld electronic devices are becoming more versatile.

Hence, to ensure that the R&D process of a handheld electronic device will be efficient and the functions of the handheld electronic device will be brought into full play, the handheld electronic device has to undergo pre-delivery tests, such as a test that entails alternating between start and shutdown, and a test for determining whether a specific selected path of an application is accessible.

The aforesaid tests are conducted by hand according to the prior art in an inefficient and error-stricken manner. For example, a test as to whether an application is executed well usually yields a test result prone to errors, because the way of accessing the application varies from test undertaker to test undertaker. As a result, chances are that the application malfunctions and thus is no longer executable when operated in a specific way.

### SUMMARY

It is an objective of the present invention to enhance testing efficiency and cut manpower costs.

Another objective of the present invention is to reduce the likelihood of a test-related error.

Yet another objective of the present invention is to provide an automated testing system and an automated test method.

In order to achieve the above and other objectives, the present invention provides a testing system for a handheld electronic device installed with an open operating platform and installed with a test instruction execution program. The test instruction execution program executes a functional test based on a test instruction received. The testing system comprises a master control computer and a transmission line. The master control computer comprises: a test program library having a plurality of test programs stored therein; a test item managing module connected to the test program library for selecting the test programs and generating a test control instruction according to the test programs selected; a test instruction module connected to the test program library and the test item managing module for sequentially executing the test programs selected based on the test control instruction received and sending the test instruction corresponding to the test programs executed to the test instruction execution program of the handheld electronic device; and a test result managing module for receiving a test result fed back from the test instruction execution program of the handheld electronic device and storing the test result. The transmission line is connected to the master control computer and the handheld electronic device for transmitting the test instruction and the test result.

In order to achieve the above and other objectives, the present invention provides a testing method for a handheld electronic device installed with an open operating platform and installed with a test instruction execution program. The handheld electronic device is tested by at least one test program stored in a master control computer. The testing method comprises the steps of: connecting the master control computer and the handheld electronic device with a transmission line; selecting the at least one test program stored in the master control computer; sending via the transmission line a test instruction from the master control computer to the test instruction execution program installed on the handheld electronic device based on the test program selected; executing a functional test procedure based on the test instruction by the test instruction execution program; and feeding back a test result to the master control computer via the transmission line by the test instruction execution program.

In an embodiment, the open operating platform is an Android operating platform.

In an embodiment, the test program library separates the test programs into random event test programs, consecutive application start and shutdown test programs, pressure test programs, power management test programs, and memory monitoring test programs.

In an embodiment, the transmission line is a USB transmission line for connecting the master control computer and a USB port of the handheld electronic device.

Accordingly, with the master control computer being capable of integrating and managing test programs, complete test programs can be installed on the master control computer and further edited or amended individually and at any time. A transmission line connects the master control computer and a handheld electronic device. Hence, the test programs installed can be much more compatible with a test instruction execution program installed on the handheld electronic device under the framework of an open operating platform to thereby achieve the objectives of the present invention.

### BRIEF DESCRIPTION

Objectives, features, and advantages of the present invention are hereunder illustrated with specific embodiments in conjunction with the accompanying drawings, in which:

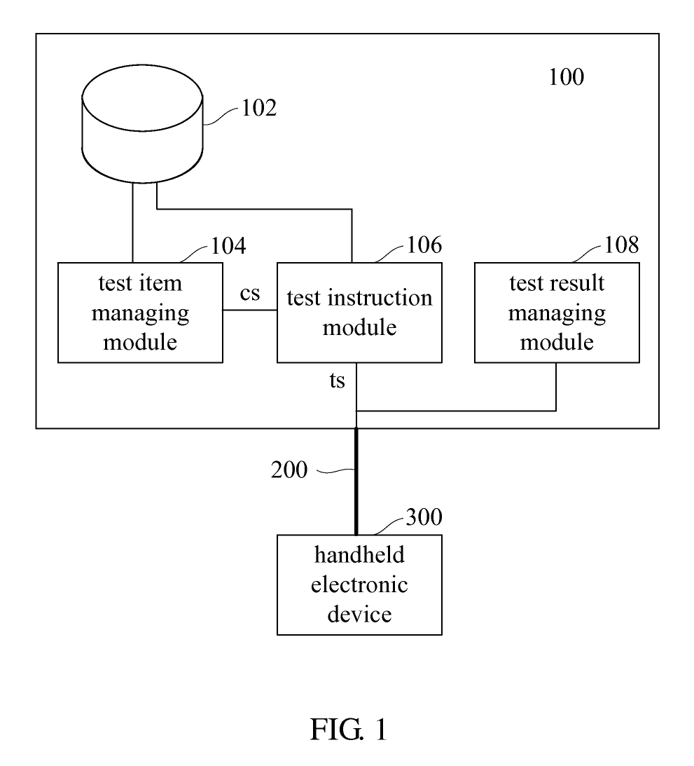

FIG. 1 is a function block diagram of a testing system in an embodiment of the present invention; and

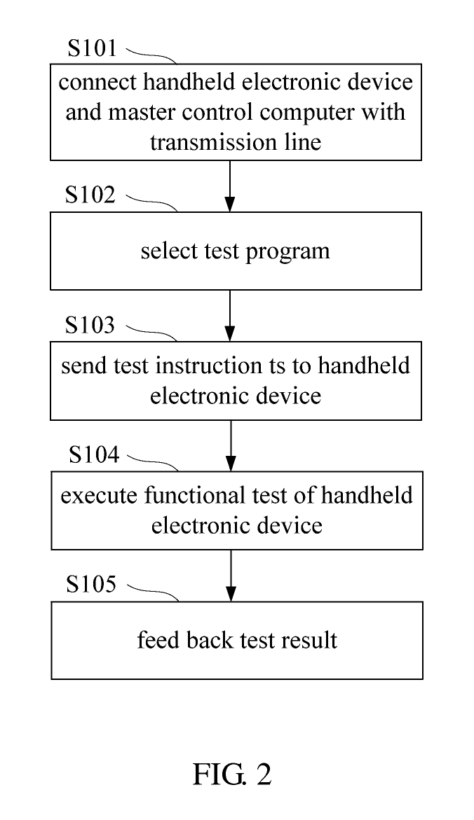

FIG. 2 is a flow chart of a testing method in an embodiment of the present invention.

### DETAILED DESCRIPTION

Referring to FIG. 1, there is shown a function block diagram of a testing system in an embodiment of the present invention. A testing system and method in an embodiment of the present invention are based on an open operating platform and apply to a handheld electronic device installed with an Android operating platform, for example. Under the framework of an open operating platform, the testing system in an embodiment of the present invention comprises a medium, that is, a test instruction execution program installed on the handheld electronic device in advance, and the medium works in conjunction with test programs to transmit a test instruction and feed back a test result.

As shown in FIG. 1, the testing system comprises a master control computer 100 and a transmission line 200. The master control computer 100 has at least one test program stored therein and sends via the transmission line 200 a test instruction to the test instruction execution program installed on a handheld electronic device 300 in advance. The master control computer 100 comprises a test program library 102, a test item managing module 104, a test instruction module 106, and a test result managing module 108.

The test program library 102 is stored with the test programs. In an aspect of the present invention, the test program library 102 separates the test programs into random event test programs, consecutive application start and shutdown test programs, pressure test programs, power management test programs, and memory monitoring test programs.

The test item managing module 104 is connected to the test program library 102 and the test instruction module 106. Test items which match each of the test programs in the test program library 102 are rendered, by the test item managing module 104, accessible to an operation worker for selection. The operation worker can create a test program code or delete an otherwise existing program code with the test item managing module 104 and store a new test program in the test program library 102. The test item managing module 104 is programmed in Java programming language, for example, to enable the test programs to be edited later. Once the operation worker marks the selected test programs in the test program library 102 with the test item managing module 104, the test item managing module 104 will generate and send a test control instruction cs accordingly.

The test instruction module 106 is connected to the test program library 102 and the test item managing module 104. The test instruction module 106 sequentially executes the selected (i.e. marked) test programs in the test program library 102 based on the test control instruction cs received. With the test instruction module 106 being accessible to the test instruction execution program installed on the handheld electronic device 300, a test instruction is sent from the selected and executed test programs can be directly admitted to every layer of an open operating platform by means of the test instruction execution program and executed, and a response of the handheld electronic device 300, that is, a test result, is fed back from the test instruction execution program. Or, alternatively, another test program monitors the response of the handheld electronic device 300, such that a test is conducted with at least two test programs in collaboration.

The test result managing module 108 receives a test result fed back from the test instruction execution program of the handheld electronic device 300 and stores the test result in a memory unit (not shown), for example.

Referring to FIG. 2, there is shown a flow chart of a testing method in an embodiment of the present invention.

Step S101 involves connecting the master control computer 100 and the handheld electronic device 300 with the transmission line 200.

Step S102 involves selecting at least one test program stored in the master control computer 100.

Step S103 involves sending via the transmission line 200 a test instruction ts from the master control computer 100 to the test instruction execution program installed on the handheld electronic device 300 based on the test program selected.

Step S104 involves instructing, by the test instruction execution program, the handheld electronic device 300 to execute a functional test procedure based on the test instruction ts.

Step S105 involves feeding back a test result to the master control computer 100 via the transmission line 200 by the test instruction execution program.

In an embodiment of the present invention, the transmission line 200 is a USB transmission line and thus is of high compatibility.

In conclusion, with a master control computer being capable of integrating and managing test programs and a test instruction execution program being installed on a handheld electronic device under the framework of an open operating platform, the test programs can be automatically integrated under the framework of the open operating platform to enhance testing efficiency and accuracy of a test result, such that the test result is presented in detail and precisely.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A testing system for a handheld electronic device installed with an open operating platform and installed with a test instruction execution program for executing a functional test based on a test instruction received, the testing system comprising:
a master control computer, comprising:
a test program library having a plurality of test programs stored therein;
a test item managing module connected to the test program library for selecting the test programs and generating a test control instruction according to the test programs selected;
a test instruction module connected to the test program library and the test item managing module for sequentially executing the test programs selected based on the test control instruction received and sending the test instruction corresponding to the test programs executed to the test instruction execution program of the handheld electronic device; and
a test result managing module for receiving a test result fed back from the test instruction execution program of the handheld electronic device and storing the test result; and
a transmission line connected to the master control computer and the handheld electronic device for transmitting the test instruction and the test result.

2. The testing system of claim 1, wherein the open operating platform is an Android operating platform.

3. The testing system of claim 1, wherein the test program library separates the test programs into random event test programs, consecutive application start and shutdown test programs, pressure test programs, power management test programs, and memory monitoring test programs.

4. The testing system of claim 1, wherein the transmission line is a USB transmission line for connecting the master control computer and a USB port of the handheld electronic device.

5. A testing method for a handheld electronic device installed with an open operating platform and installed with a test instruction execution program, wherein the handheld electronic device is tested by at least one test program stored in a master control computer, the testing method comprising the steps of:
connecting the master control computer and the handheld electronic device with a transmission line;
selecting the at least one test program stored in the master control computer;
sending via the transmission line a test instruction from the master control computer to the test instruction execution program installed on the handheld electronic device based on the test program selected;
executing a functional test procedure based on the test instruction by the test instruction execution program; and
feeding back a test result to the master control computer via the transmission line by the test instruction execution program.

6. The testing method of claim 5, wherein the open operating platform is an Android operating platform.

7. The testing method of claim 5, wherein the transmission line is a USB transmission line.

8. The testing method of claim 5, wherein the master control computer has the test programs stored therein and separates the test programs into random event test programs, consecutive application start and shutdown test programs, pressure test programs, power management test programs, and memory monitoring test programs.
